(19) United States
(12) Patent Application Publication
(10) Pub. No.: US 2009/0306297 A1
(43) Pub. Date: Dec. 10, 2009

(54) PROCESS FOR PREPARING A COPOLYMER WITH CONTROLLED ARCHITECTURE, OF TELOMER OR BLOCK COPOLYMER TYPE, OBTAINED FROM VINYL PHOSPHONATE MONOMERS, BY IODINE TRANSFER POLYMERIZATION

(75) Inventors: Mathias Destarac, Paris (FR); Bernard Boutevin, Montpellier (FR); David Ghislain, Montpellier (FR); Graham Otter, Bromsgrove (GB); Gary Woodward, Northwich (GB)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignees: CENTRE NATIONAL DE LA RECHERCHE SCIENTIFIQUE, Paris (FR); Rhodia Operations, Aubervilliers (FR)

(21) Appl. No.: 12/162,341

(22) PCT Filed: Jan. 24, 2007
(86) PCT No.: PCT/EP07/50704

§ 371 Date: May 22, 2009

(30) Foreign Application Priority Data
Jan. 26, 2006 (FR) 06 00715

(51) Int. Cl. C08L 43/02; C08L 39/06

(52) U.S. Cl. 525/205; 525/209

(57) ABSTRACT

The present invention relates to a process for synthesizing a copolymer having controlled architecture, comprising at least one block A obtained by the ITP polymerization of a mixture of ethylenically unsaturated monomers (A₀), containing no monomers having vinyl phosphonate functions, and at least one block B obtained by polymerizing a mixture of ethylenically un-saturated monomers (B₀) containing at least one monomer B₁ which carries at least one vinyl phosphonate function. The present invention also relates to a process for synthesizing a copolymer having controlled architecture, of the telomer type, comprising at least one chain B obtained by polymerizing a mixture of ethylenically unsaturated monomers (B₀) containing at least one monomer B₁ which carries at least one vinyl phosphonate function, by ITP polymerization; to the telomer obtainable; and to the uses thereof.

A subject matter of the present invention is a process for the synthesis of a controlled-architecture copolymer comprising at least one block A obtained by the polymerization of ITP type of a mixture of monomers having ethylenic unsaturation (A₀) not comprising monomers having vinylphosphonate functional groups and at least one block B obtained by the polymerization of a mixture of monomers having ethylenic unsaturation (B₀) comprising at least one monomer B₁ carrying at least one vinylphosphonate functional group.

Another subject matter of the present invention is a process for the synthesis of a controlled-architecture copolymer of telomer type comprising at least one chain B obtained by the polymerization of a mixture of monomers having ethylenic unsaturation (B₀) comprising at least one monomer B₁ carrying at least one vinylphosphonate functional group by polymerization of ITP type, and also the telomer capable of being obtained and its uses.

According to the present invention, controlled-architecture copolymers denote block copolymers, such as diblocks and triblocks, grafted copolymers, star copolymers, microgels or branched block copolymers comprising a microgel core with a variable and controlled crosslinking density (such as described in the application M. Destarac, B. Bavouzet and D. Taton, WO 2004/014535, Rhodia Chimie), and also telomers, that is to say polymers having controlled end functionality.

The term “monomer having a vinylphosphonate functional group” is understood to mean, within the meaning of the present invention, a monomer which comprises at least one vinylphosphonic acid functional group or an alkyl ester analog.

Mention may in particular be made, among monomers having a vinylphosphonate functional group, of the compounds of following formula (I):

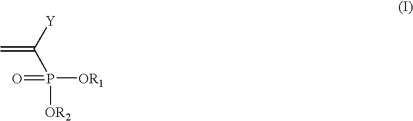

in which:
Y represents a radical chosen from a hydrogen atom, an alkyl radical having from 1 to 6 carbon atoms, a cyano, a phenyl radical, an ester radical of formula —COOR₃, an acetate radical of formula —OCOR′₃, a phosphonic acid or a methyl, ethyl or isopropyl ester of phosphonic acid;
R₃ and R′₃, which are identical or different, represent an alkyl radical having from 1 to 12 carbon atoms and preferably an alkyl radical having from 1 to 6 carbon atoms;
R₁ and R₂, which are identical or different, represent a hydrogen atom or an alkyl radical having from 1 to 6 carbon atoms which is optionally substituted by a halogen atom;
   the term “halogen atom” is understood to mean chlorine, fluorine, bromine or iodine. Preferably, chlorine is used.

The blocks or chains according to the invention can be homopolymers, random copolymers, alternating copolymers or copolymers having a composition gradient.

One of the technological approaches of choice which makes it possible to synthesize controlled-architecture copolymers is “living” or controlled radical polymerization.

Controlled-architecture copolymers are of use in various industries, in particular as dispersing, emulsifying, texturizing or surface-modifying agents.

Furthermore, (co)polymers carrying phosphonic acid functional groups are well developed industrially for their specific functions in varied fields, such as flame retardants, scale-inhibiting agents, corrosion inhibitors, adhesion promoters or pigment dispersants.

Thus, it is apparent that the synthesis of copolymers having complex architectures carrying phosphonate functional groups PO₃R₁R₂ and in particular phosphonic acid functional groups PO₃H₂ represents a very great industrial challenge.

This is also a technical challenge quite capable of being accepted, for two main reasons:
first of all, the range of industrial monomers carrying a phosphonate functional group PO₃R₁R₂ is very limited. Most are vinyl monomers, such as vinylphosphonic acid, the dimethyl ester of vinylphosphonic acid, the bis(2-chloroethyl) ester of vinylphosphonic acid, vinylidenediphosphonic acid or the tetraisopropyl ester of vinylidenediphosphonic acid;
their low reactivity in polymerization, combined with the phosphonic acid or phosphonate functionality of some of the monomers listed, has always greatly compromised their use in a “living” or controlled radical polymerization process.

This is the reason why, to date, the synthesis of homopolymers or copolymers comprising monomers comprising phosphonate functional groups has been carried out by a conventional radical route, that is to say by an uncontrolled mechanism.

The phosphonic acid functional groups PO₃H₂ are often generated by the hydrolysis of the corresponding esters, which can be provided by an appropriate monomer [Boutevin B. et al., Polym. Bull., 1993, 30, 243] or transfer agent [Boutevin B. et al., Macromol. Chem. Phys., 2002, 203, 1049] during the polymerization.

Very few studies relate to the direct incorporation of PO₃H₂ functional groups in polymers. This is, for example, the case in polymerizing vinylphosphonic acid, hereinafter denoted by VPA, by radical initiation [Herwig W., Duersch W. and Engelhardt F., U.S. Pat. No. 4,696,987] or by random copolymerization, for example with methacrylic acid [Riegel U., Gohla W., Grosse J. and Engelhardt F., U.S. Pat. No. 4,749,758]. The document GB 2 293 605 describes the polymerization of VPA and its random copolymerization with acrylic acid. Likewise, R. Padda et al. [Phosphorus, Sulfur and Silicon and the Related Elements, 2002, 177 (6-7), 1697] describe the random copolymerization of a diphosphonic monomer: vinylidenediphosphonic acid. With regard to the telomers, that is to say polymers having controlled chain endings, functionalized by PO₃H₂, Rhodia has developed a technology which makes it possible to synthesize polymers (for example, polyacrylic acid (PAA)) having a diphosphonic acid di(PO₃H₂) end unit [Davis et al., WO 2004/078662].

It is apparent that the polymers having phosphonate or phosphonic acid functional groups most commonly described are homopolymers, random copolymers, and even telomers, functionalized by a phosphonic acid at their end, these polymers being obtained by a conventional radical route, that is to say by an uncontrolled mechanism.

Mention may be made, among the main “living” or controlled radical polymerization techniques, of atom transfer radical polymerization (ATRP), radical polymerization controlled by stable radicals of nitroxyl type (NMP), reversible addition-fragmentation transfer (RAFT) polymerization and polymerization by degenerative transfer of iodine (ITP).

However, for ATRP, the phosphonic acid units and the ester analogs of the vinyl monomers and/or of the polymers formed have a tendency to strongly interact with the ATRP catalysts (Cu, Ru, Fe, Ni), which compromises the control of this polymerization.

For the NMP polymerization, the low level of stabilization of the radicals resulting from the vinylphosphonic acid monomers or from their ester analogs renders the polymerization of these monomers difficult to make compatible with this technique.

In the case where the polymerization is of RAFT type, in particular when the RAFT transfer agent is a xanthate, a process then referred to as the MADIX process (Macromolecular Design via the Interchange Xanthates), VPA has been randomly copolymerized with acrylic acid. Hydrophilic double copolymers P(acrylamide)-b-P(AA-stat-VPA) have been synthesized as described in the document M. Destarac and D. Taton, “Direct Access to Phosphonic Acid-Containing Block Copolymers via MADIX”, 40th International Symposium on Macromolecules, MACRO 2004, Paris. Amphiphilic copolymers P(BuA)-b-P(AA-stat-VPA) have been synthesized as described in the documents WO 2003/076529 and WO 2003/076531.

However, it is important to note that, in all the cases of MADIX polymerization described above, the level of incorporation of VPA in a block did not exceed 25 mol %.

In the academic literature, radical polymerization controlled by iodine transfer (ITP) or also by degenerative transfer (DT) has been described by M. Tatemoto in “Development of iodine Transfer Polymerization and its applications to telechelically reactive polymers”, Kobunshi Robunshu, vol. 49, No. 10, pp. 765-783 (1992). In this process, an end iodine atom (at the chain end) can be reversibly transferred during the polymerization from a chain end to a growing radical of another chain. The transfer agents commonly employed are alkyl or perfluoroalkyl iodides.

For the case of styrene and acrylates, mention may be made of the studies of Gaynor et al. in Macromolécules, 28, 8051-8056 (1995). Other examples of polymerization of styrene monomers by ITP are available in the references Macromolécules, 33(9), 3485 (2000), Macromolécules, 32(22), 7354 (1999) and Macromolécules, 31(9), 2809 (1998). The synthesis by ITP of block copolymers based on styrene and on acrylates has been described in the references Macromolécules, 28, 2093 (1995) and Macromol. Rapid Commun. 2000, 21(13), 921.

The ITP of vinyl acetate has been studied by Iovu et al. in Macromolécules, 2003, 36(25), 9346-9354.

Lacroix-Desmazes et al. in ACS Symposium Series, 854, 570-585 (2003), have studied the ITP polymerization of vinylidene chloride and have synthesized the corresponding block copolymers. These same authors have recently described, in Macromolécules, 2005, 38(15), 6299-6309, the radical polymerization of acrylates using molecular iodine I₂, thereby naming this process reverse ITP or RITP.

The documents EP 0 489 370 and U.S. Pat. No. 5,439,980 from Daikin Industries describe the synthesis of block copolymers by reversible iodine transfer.

The documents EP 272 698 and EP 0 501 532 from Daikin industries describe the polymerization by ITP of fluoromonomers in order to access fluorinated block copolymers.

The documents EP 0 617 057, EP 0 974 604 and U.S. Pat. No. 5,455,319 from Geon Company relate to the ITP polymerization of halogenated monomers, in particular vinyl chloride.

The document EP 0 947 527 from B.F. Goodrich Company describes aqueous emulsion ITP polymerization in order to access in particular ABC triblock copolymers.

The document WO 03/097704 from Solvay describes the iodine transfer polymerization of compositions formed of halogenated monomers for some cases in the presence of molecular iodine I₂ as transfer agent.

The document WO 2004/009648 from Akzo Nobel describes the synthesis of controlled-architecture copolymers by iodine transfer polymerization for which one of the blocks is rich in methacrylate monomers.

In the document WO 2004/009644 from Akzo Nobel, molecular iodine I₂ is employed to control the polymerization of a methacrylic composition comprising at least one crosslinkable functional group.

Thus, none of the abovementioned documents relating to polymerization controlled by iodine transfer (ITP) describes the use of a monomer having a vinylphosphonate acid functional group.

The need existed to succeed in synthesizing block polymers, one of the blocks of which has a high composition of monomer having a vinylphosphonate functional group.

Specifically, the vinylphosphonate monomer is a relatively unreactive monomer which is generally much more expensive than the comonomers which accompany it in the reaction mixture. The fact of being capable of localizing it at will in a precise part of the polymer should make it possible to use less of it in achieving the desired property and thus to reduce the cost.

Furthermore, the fact of having several consecutive vinylphosphonate units in a polymer should make it possible to introduce advantageous properties, in particular when the polymers thus obtained are used as scale-inhibiting agents.

One of the aims of the present invention is to find a means of synthesizing controlled-architecture copolymers comprising at least one block based on monomers carrying vinylphosphonate functional groups with a high composition of vinylphosphonate functional groups.

This aim and others have been achieved by the Applicant Company by using a specific radical polymerization process of iodine atom transfer type (ITP).

Specifically, it is by virtue of the control of the reaction conditions, in terms of concentration of the reaction medium, and the conditions of temperature and of concentration of initiator and the nature and the concentration of the iodine-comprising transfer agent, that the Applicant Company has been able to obtain controlled-architecture polymers comprising blocks rich in vinylphosphonate monomer.

The subject matter of the present invention is thus a process for the synthesis of a controlled-architecture copolymer comprising at least one block A obtained by the polymerization of a mixture of monomers having ethylenic unsaturation (A₀) not comprising monomers having vinylphosphonate functional groups and at least one block B obtained by the polymerization of a mixture of monomers having ethylenic unsaturation (B₀) comprising at least one monomer B₁ carrying at least one vinylphosphonate functional group comprising the following stages:
(a) a radical polymerization is carried out which results in the production of a polymer functionalized at its end by an iodine atom of use as transfer agent in a controlled radical polymerization reaction, said stage being carried out by bringing into contact:
   ethylenically unsaturated monomer molecules,
   a source of free radicals, and
   at least one iodine-comprising transfer agent;
(b) a stage of radical polymerization, or several successive stages of radical polymerizations, is/are carried out subsequent to stage (a), said stage(s) each consisting in carrying out a radical polymerization which results in the production of a block copolymer functionalized at its end by an iodine atom of use as transfer agent in a radical polymerization reaction, said stage or stages being carried out by bringing into contact:
   ethylenically unsaturated monomer molecules, at least one of which is different from those employed in the preceding stage,
   a source of free radicals, and
   the functionalized polymer resulting from the preceding stage;
   it being understood that one of the polymerization stages (a) and (b) defined above results in the formation of the block B, that is to say of the block comprising the vinylphosphonate functional groups, and that another of the polymerization stages of stages (a) and (b) results in the formation of another block, in this instance the block A,
   the ethylenically unsaturated monomers employed in stages (a) and (b) being chosen from the appropriate monomers in order to obtain a controlled-architecture copolymer as defined above.

Another subject matter of the present invention is a process for the synthesis of a controlled-architecture copolymer of telomer type comprising at least one chain B obtained by the polymerization of a mixture of monomers having ethylenic unsaturation (Bo) comprising at least one monomer B₁ carrying at least one vinylphosphonate functional group comprising the following stage:

the following are brought into contact:
ethylenically unsaturated monomer molecules,
a source of free radicals, and
at least one iodine-comprising transfer agent.

Another subject matter of the present invention is a controlled-architecture copolymer of telomer type capable of being obtained by the process of synthesis of the invention.

Finally, a subject matter of the present invention is the use of the controlled-architecture copolymer of telomer type capable of being obtained by the process of synthesis of the invention as surface-modifying agent, as dispersant or as emulsifier.

The controlled-architecture copolymer can be a block (di- or triblock) copolymer, a grafted copolymer, a star copolymer or a microgel, comprising at least one block A and at least one block B, and also a telomer comprising a chain B.

The block A according to the invention is obtained by the polymerization of a mixture of monomers having ethylenic unsaturation (A₀) not comprising monomers having vinylphosphonate functional groups. The block B is obtained by the polymerization of a mixture of monomers having ethylenic unsaturation (B₀) comprising at least one monomer B₁ carrying a vinylphosphonate functional group.

The blocks according to the invention can be homopolymers, random copolymers, alternating copolymers or copolymers having a composition gradient.

According to the invention, the ratio by weight of the blocks A and B varies between 1/99 and 99/1.

The block A is obtained by the polymerization of a mixture of monomers (A₀) having ethylenic unsaturation not comprising monomers carrying a vinylphosphonate functional group. The group (A₀) comprises hydrophilic monomers (h) or hydrophobic monomers (H) chosen from the following monomers:

Mention may be made, among hydrophilic monomers (h), of:
unsaturated ethylenic mono- and dicarboxylic acids, such as acrylic acid, methacrylic acid, itaconic acid, maleic acid or fumaric acid, and their derivatives, such as the monoalkyl esters, preferably with C₁-C₄ alcohols, and the amides, such as acrylamide or methacrylamide, or
ethylenic monomers comprising a ureido group, such as ethylene urea ethyl methacrylamide or ethylene urea ethyl methacrylate, or
ethylenic monomers comprising a sulfonic acid group or one of its alkali metal or ammonium salts, such as, for example, vinylsulfonic acid, vinylbenzenesulfonic acid, α-acrylamidomethylpropanesulfonic acid or 2-sulfoethyl methacrylate, or
monomers carrying a boronic acid functional group, such as p-vinylphenylboronic acid, or
cationic monomers chosen from aminoalkyl (meth)acrylates or aminoalkyl(meth)acrylamides; monomers comprising at least one secondary, tertiary or quaternary amine functional group or a heterocyclic group comprising a nitrogen atom; diallyldialkylammonium salts; these monomers being taken alone or as mixtures, and also in the form of salts, the salts preferably being chosen so that the counterion is a halide, such as, for example, a chloride, or a sulfate, a hydrosulfate, an alkyl sulfate (for example comprising 1 to 6 carbon atoms), a phosphate, a citrate, a formate or an acetate, such as dimethylaminoethyl(meth)acrylate, dimethylaminopropyl (meth)acrylate, di(tert-butyl)aminoethyl (meth)acrylate, dimethylaminomethyl(meth)acrylamide, dimethylaminopropyl(meth)acrylamide; ethylenimine, vinylamine, 2-vinylpyridine, 4-vinylpyridine; trimethylammonioethyl(meth)acrylate chloride, trimethylammonioethyl acrylate methyl sulfate, benzyldimethylammonioethyl(meth)acrylate chloride, (4-benzoylbenzyl)dimethylammonioethyl acrylate chloride, trimethylammonioethyl(meth)acrylamide chloride, trimethyl(vinylbenzyl)ammonium chloride; diallyldimethylammonium chloride, alone or as mixtures, or their corresponding salts, or
cyclic amides of vinylamine, such as N-vinylpyrrolidone and vinylcaprolactam, or
the polyvinyl alcohol resulting from the hydrolysis of a polyvinyl acetate, for example, or
more generally, the hydrophilic polymers originating from a chemical modification of a hydrophobic block, for example by hydrolysis of a polyalkyl acrylate to give polyacrylic acid.

Preferably, the hydrophilic monomer units (h) are chosen from acrylic acid (AA), acrylamide (Am), 2-acrylamido-2-methylpropanesulfonic acid (AMPS), styrenesulfonate (SS), N-vinylpyrrolidone, vinylsulfonic acid (VSA), or their mixtures, and the vinyl alcohol units resulting from the hydrolysis of polyvinyl acetate, or their mixtures.

More preferably still, acrylic acid (AA) or vinyl alcohol units are used.

Mention may be made, among monomers having a hydrophobic (H) nature, of;
styrene-derived monomers, such as styrene, α-methylstyrene, para-methylstyrene or para-(tert-butyl)styrene, or
esters of acrylic acid or methacrylic acid with C₁-C₁₂, preferably C₁-C₈, alcohols which are optionally fluorinated, such as, for example, methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate,
vinyl nitriles comprising from 3 to 12 carbon atoms, in particular acrylonitrile or methacrylonitrile,
vinyl esters of carboxylic acids, such as vinyl acetate (VAc), vinyl versatate or vinyl propionate,
vinyl or vinylidene halides, for example vinyl chloride, vinyl fluoride, vinylidene chloride and vinylidene fluoride, and
diene monomers, for example butadiene or isoprene.

Preferably, the hydrophobic monomer units (H) of the controlled-architecture copolymers of the invention are esters of acrylic acid with linear or branched C₁-C₈, in particular C₁-C₄, alcohols, such as, for example, methyl acrylate, ethyl acrylate, propyl acrylate, butyl acrylate (BuA) or 2-ethylhexyl acrylate (2EHA), fluorinated acrylates, or else styrene derivatives, such as styrene, or vinyl acetate (VAc), or vinyl chloride, or vinylidene chloride, or vinylidene fluoride.

According to a preferred form of the invention, the block A is polyacrylic acid or polyvinyl alcohol.

The polyacrylic acid can be obtained either by polymerization of acrylic acid monomer or by polymerization of a monomer of alkyl acrylate type, such as, for example, methyl acrylate or butyl acrylate, followed by hydrolysis.

The polyvinyl alcohol can be obtained by polymerization of vinyl acetate, followed by hydrolysis.

As regards the block B or the chain B, it is obtained by the polymerization of a mixture of monomers (B₀) comprising at least one monomer B₁ carrying at least one vinylphosphonate functional group and optionally a monomer B₂ not carrying a vinylphosphonate functional group chosen from the group A₀ defined above.

Preferably, the block B or the chain B is obtained by the polymerization of a mixture of monomers (B₀) comprising,
from 20 to 100 mol % of at least one monomer B₁ carrying at least one vinylphosphonate functional group, and
from 0 to 80 mol % of at least one monomer B₂ not carrying a vinylphosphonate functional group chosen from the group A₀ defined above.

More preferably still, the block B or the chain B is obtained by the polymerization of a mixture of monomers (B₀) comprising,
from 50 to 100 mol % of at least one monomer B₁ carrying at least one vinylphosphonate functional group, and
from 0 to 50 mol % of at least one monomer B₂ not carrying a vinylphosphonate functional group chosen from the group A₀ defined above.

The monomer comprising at least one vinylphosphonate functional group B₁ can be a compound of formula (I):

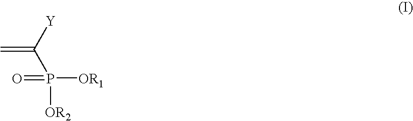

in which:
Y represents a radical chosen from a hydrogen atom, an alkyl radical having from 1 to 6 carbon atoms, a cyano, a phenyl radical, an ester radical of formula —COOR₃, an acetate radical of formula —OCOR′₃, a phosphonic acid or a methyl, ethyl or isopropyl ester of phosphonic acid;
R₃ and R′₃, which are identical or different, represent an alkyl radical having from 1 to 12 carbon atoms and preferably an alkyl radical having from 1 to 6 carbon atoms;
R₁ and R₂, which are identical or different, represent a hydrogen atom or an alkyl radical having from 1 to 6 carbon atoms which is optionally substituted by a halogen atom;
   or their mixtures,
   it being understood that, when the block B is obtained by the polymerization of a mixture of monomers (Bo) comprising from 50 to 100 mol % of at least one monomer B₁ and when B₁ adheres to the formula (I) with Y other than a hydrogen atom, then the block B also comprises monomers B₁ in which Y represents a hydrogen atom.

The term “halogen atom” is understood to mean chlorine, fluorine, bromine or iodine. Preferably, chlorine is used.

Mention may in particular be made, among the monomers B₁ of use in the present invention, of vinylphosphonic acid, the dimethyl ester of vinylphosphonic acid, the bis(2-chloroethyl) ester of vinylphosphonic acid, vinylidenediphosphonic acid, the tetraisopropyl ester of vinylidenediphosphonic acid or α-styrenephosphonic acid, or their mixtures.

The monomers B₁ having a vinyl mono- or diphosphonic acid functional group can be used in the free acid form or in the form of their salts. They can be partially or completely neutralized, optionally by an amine, for example dicyclohexylamine.

The monomer B₁ which is preferred according to the invention is vinylphosphonic acid.

The monomer B₂ of use in the present invention can be chosen from the monomers A₀ defined above.

Preferably, the monomer B₂ is chosen from acrylic acid, acrylamide, vinylsulfonic acid, vinyl acetate, butyl acrylate or their mixtures.

More preferably still, the monomer B₂ is acrylic acid.

In general, the controlled-architecture copolymers exhibit a weight-average weight of between 1000 and 100 000, generally between 4000 and 50 000. They also exhibit a polydispersity index of less than 2.5, preferably of between 1.3 and 2.5 and more preferably between 1.3 and 2.0.

The ratio by weight between blocks A and B is such that B/(A+B) is preferably between 0.01 and 0.5 and more preferably still between 0.02 and 0.2.

When the block B is obtained by the polymerization of a mixture of monomers (B₀) comprising from 50 to 100 mol % of at least one monomer B₁ carrying at least one vinylphosphonate functional group, then the following conditions preferably exist:
the concentration of monomer B₀ in the medium is such that the level of solid must be greater than 50%, preferably greater than 60% and more preferably still greater than 70%, the level of solid being defined in the following way: weight B₀/weight (B₀+solvent), if B₀ is polymerized as first block,
weight(A₀+B₀)/weight(A₀+B₀+solvent), if B₀ is polymerized as second block; and
the cumulative or total concentration of the initiator is between 0.5 and 20 mol %, with respect to the mixture of monomers B₀.

The molecular weights of the block B are generally less than 10 000, preferably less than 5000 and more preferably still less than 2000.

The concentration of initiator and the method of introduction of the initiator are defined so as to obtain a good compromise between a high conversion of monomer B₀ and a level of uncontrolled chains which is as low as possible.

Thus, the initiator is introduced batchwise at the beginning of the reaction, or portionwise, or continuously or semicontinuously, the monomer B, being placed, preferably as vessel heel, such that the cumulative or total concentration of the initiator is between 0.5 and 20 mol %, with respect to the mixture of monomers B₀.

The level of solid made of monomer B₀ is high in comparison with the usual conditions under which controlled radical polymerization processes are carried out.

Finally, the molecular weights of the block B have also been defined so as to effectively control the polymerization.

The iodine-comprising transfer agents of use by virtue of the invention all have at least one group which stabilizes the radical centered on the carbon adjacent to the iodine atoms. This group activates the reactants with regard to the transfer of iodine and for this reason renders the transfer agents effective. The iodine-comprising transfer agents can be classified into three categories:
i) monoiodine compounds without a functional group of formula R—I (II),
ii) monoiodine compounds with a functional group of formula Z₂-R′—I (III),
iii) diiodine compounds of formula I—R′—I (IV).

The iodine-comprising transfer agent of use for the implementation of the processes of the invention can be chosen from reactive monoiodine compounds without a functional group of following formula (II):

R—I (II)

in which
R represents:
an alkyl, acyl, aryl, alkenyl or alkynyl group;
a saturated or unsaturated, optionally aromatic, carbon ring;
a saturated or unsaturated, optionally aromatic, heterocycle;
a polymer chain;
an iodine atom; or
HI₂C—;
   when R is other than an iodine atom or the HI₂C— radical, it additionally comprises at least one group which stabilizes the radical R′ and has from 1 to 50 carbon atoms, the polymer and the group which stabilizes the radical being bonded to the same carbon atom in R,
   the group which stabilizes the radical R′ can be aryl, alkene, ester, acid, amide, ketone, nitrile, halogen, isocyanate, nitro and amine.

Examples of groups which stabilize the radicals R′ are C₆H₄ CH₃, C₆H₅, (C═O)OCH₃, F, Cl and CN.

Mention may be made, as examples, among compounds R—I, of 1-chloro-1-iodoethane, 1-fluoro-1-iodoethane, 1-phenyl-1-iodoethane, monoiodoperfluoroethane, monoiodoperfluoropropane, 2-iodoperfluorobutane, 1-iodoperfluorobutane, 1-iodoperfluoro(4-methylbutane), 1-iodoperfluorohexane, 1-iodoperfluoro-n-nonane, monoiodoperfluorocyclohexane, monoiodotrifluorocyclobutane, monoiododifluoromethane, monoiodomonofluoromethane, 2-iodo-1-hydroperfluoroethane, 3-iodo-1-hydroperfluoropropane, monoiodomonochlorodifluoromethane, monoiododichloromonofluoroethane, 2-iodo-1,2-dichloro-1 μl, 2-trifluoroethane, 4-iodo-1,2-dichloroperfluorobutane, 6-iodo-1,2-dichloroperfluorohexane, 4-iodo-1,2,4-trichloroperfluorobutane, 1-iodo-2,2-dihydroperfluoropropane, 1-iodo-2-hydroperfluoropropane, monoiodotrifluoroethane, 3-iodoperfluoroprop-1-ene, 4-iodoperfluoropentene, 1,4-iodo-5-chloropent-1-ene, 2-iodoperfluoro(1-cyclobutenyl)ethane, 1-iodoperfluorodecane, 2-iodo-1,1,1-trifluoroethane, 1-iodo-1-hydroperfluoro(2-methylethane), 2-iodo-2,2-dichloro-1 μl, 1-trifluoroethane, 2-iodoperfluoroethyl perfluorovinyl ether, 2-iodoperfluoroethyl perfluoroisopropyl ether, 3-iodo-2-chloroperfluorobutyl perfluoromethyl ether, iodopentafluorocyclohexane, iodoperfluorohexane, iodoacetonitrile, methyl 2-iodopropionate, ethyl 2-iodopropionate or benzyl iodide.

The preferred agents R—I are 1-iodoperfluorohexane (C₆F₁₃I), iodoacetonitrile (CNCH₂I), methyl 2-iodopropionate (CH₃CH(CO₂CH₃)—I), 1-phenyl-1-iodoethane (CH₃ CH(C₆H₅)—I) and benzyl iodide (C₆H₅CH₂—I).

The iodine-comprising transfer agent of use in the implementation of the process of the invention can also be chosen from monoiodine compounds carrying a functional group of following formula (III):

Z₂-R′—I (III)

in which
R′ represents:
an alkylene or arylene group;
a saturated or unsaturated, optionally aromatic, carbon ring;
a saturated or unsaturated, optionally aromatic, heterocycle; or
a polymer chain;
   with R′, as recorded above, comprising at least one group which stabilizes the radical Z₂-R′ and having from 1 to 50 carbon atoms, the polymer and the group which stabilizes the radical being bonded to the same carbon atom in Z₂-R′;
   the group which stabilizes the radical R′ can be aryl, alkene, ester, acid, amide, ketone, nitrile, halogen, isocyanate, nitro and amine;

Examples of groups which stabilize the radicals Z₂-R′ are C₆H₄CH₃, C₆H₅, (C═O)OCH₃, F, Cl and CN.

Z₂ is selected from the following groups: OR₁, N(R₁)₂, SR₁, COOR₁, COOM, olefin of the CR₁═C(R₁)₂ type, epoxy, SO₃M, P(O)(OR₁)₂, P(R₁)₂, isocyanate and CR₁═O, where R₁ is a hydrogen atom or a group having from 1 to 20 carbon atoms, R₁ being identical or different for any Z₂ having more than one R₁ group, and where M is an alkali metal salt, such as a sodium or potassium salt.

The preferred transfer agents Z₂-R′—I are 3-iodo-4-chloroperfluorobutyric acid, allyl iodide or also 1-iodo-1-phenylethanol (IIIa) or iodoacetic acid (IIIb) described below:

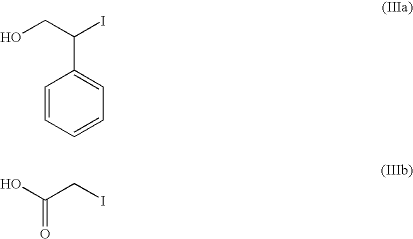

The diiodine-comprising transfer agents without a functional group are of following general formula (IV):

I—R′—I (IV)

in which:
R′ represents
an alkylene or arylene group;
a saturated or unsaturated, optionally aromatic, carbon ring;
a saturated or unsaturated, optionally aromatic, heterocycle; or
a polymer chain;
   with R′, as recorded above, comprising at least one group which stabilizes the radical R′ and having from 1 to 50 carbon atoms, the polymer and the group which stabilizes the radical being bonded to the same carbon atom in R′;
   the group which stabilizes the radical can be aryl, alkene, ester, acid, amide, ketone, nitrile, halogen, isocyanate, nitro and amine.

Examples of groups which stabilize the radicals R′ are C₆H₄CH₃, C₆H₅, (C═O)OCH₃, F, Cl and CN.

Mention may be made, among the compounds I—R′—I, as examples, of 1,3-diiodoperfluoro-n-propane, 1,4-diiodoperfluoro-n-butane, 1,3-diiodo-2-chloroperfluoro-n-propane, 1,5-diiodo-2,4-dichloroperfluoro-n-pentane, 1,7-diiodoperfluoro-n-octane, 1,12-diiodoperfluorodecane, 1,16-diiodoperfluorohexadecane, 1,2-di(iododifluoromethyl)perfluorocyclobutane, 1,4-di(iododifluoromethyl)tetrafluorocyclohexane, 1,4-di(iodomethyl)benzene (IVa), ethylene glycol di(iodomethyl) ester (IVb) and dimethyl 2,5-diiodoadipate (IVc).

The preferred reactants I—R′—I are 1,4-di(iodomethyl)benzene (IVa), ethylene glycol di(iodomethyl) ester (IVb) and dimethyl 2,5-diiodoadipate (IVc).

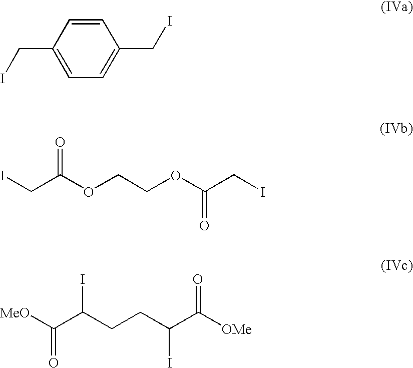

The iodine-comprising reactant selected for the polymerization depends on the type of monomer polymerized and on the controlled architecture desired. A good balance between the rate of transfer and the rate of reinitiation must be found.

The three types of iodine-comprising transfer agents of formulae (II), (III) and (IV) can be used for the synthesis of controlled-architecture copolymers in several stages and for the synthesis of telomers in one stage.

It is preferable to use iodine-comprising transfer agents of formula R—I (II) or of formula I—R′—I (IV) for the synthesis of controlled-architecture copolymers in several stages.

It is preferable to use iodine-comprising transfer agents of formula R—I (II) or Z₂-R′—I (III) for the synthesis of telomers.

The polymerization can be carried out in particular in bulk, in solvent or else in dispersed medium.

When the polymerization is carried out in solvent, said solvent is acetonitrile, ethyl acetate or an alcohol chosen from ethanol, isopropanol, or their mixtures with water, optionally.

The polymerization carried out in solvent in acetonitrile or an alcohol, such as ethanol, constitutes a preferred embodiment of the invention.

Water, an alcohol or an aqueous/alcoholic medium are more particularly recommended in the context of the use of hydrophilic monomers of the type of acrylic acid (AA), acrylamide (AM), 2-acrylamido-2-methylpropanesulfonic acid (AMPS) and styrenesulfonate (SS) and/or in the context of the use of hydrophobic monomers, such as n-butyl acrylate or 2-ethylhexyl acrylate.

Another subject matter of the invention is the use of the telomers according to the invention as surface-modifying agent (in particular as hydrophilizing, hydrophobizing or oleophobizing agent), for example for metal surfaces, as adhesion promoter, as corrosion inhibitor, as flame retardant, as dispersant or as emulsifier. It is mentioned that a copolymer where the block A comprises fluorine atoms and/or that a polymer obtained using an iodine-comprising transfer agent comprising fluorine atoms can be particularly useful in the treatment and/or modification of surfaces, for example as hydrophobizing and oleophobizing agent, being able to exhibit a corrosion-inhibiting function.

The following examples illustrate the invention without limiting the scope thereof.

### EXAMPLES

### Example 1

### Radical Polymerization of Vinylphosphonic Acid (VPA) in the Presence of Molecular Iodine I₂

5.0 g (4.67×10⁻² mol) of VPA, 0.29 g (1.77×10⁻³ mol) of azobisisobutyronitrile (AIBN), 0.18 g (7.08×10⁻⁴ mol) of iodine I₂ and 10 g of acetonitrile are introduced into a 100 ml two-necked round-bottom flask covered with a film of aluminum and equipped with a reflux condenser. The mixture is degassed using argon for 10 min at 0° C. and then placed at 80° C. with magnetic stirring. The reaction is halted when the monomer is no longer consumed. The maximum conversion achieved is 50% (measured by ³¹P NMR). The polymer is obtained by precipitating from ethyl acetate, then filtered off and stored in the dark at 0° C. A white powder is obtained.

GPC analyses in water were carried out on the product obtained and on two other polymers synthesized in the presence of variable concentrations of iodine I₂. The GPC analyses clearly show that the molar masses are controlled by the level of iodine. They increase as the starting concentration of I₂ decreases. Furthermore, an elemental analysis was carried out on a sample for which the starting concentration of I₂ corresponded to a polymer comprising 30 VPA units. The elemental analysis indeed confirms the value of the number-average degree of polymerization targeted. In addition, the elemental analysis confirms the presence of iodine.

### Example 2

### Radical Polymerization of Vinylphosphonic Acid (VPA) in the Presence of C₆F₁₃—I

5.0 g (4.67×10⁻² mol) of VPA, 0.08 g (5.09×10⁻⁴ mol) of AIBN, 0.69 g (1.54×10⁻³ mol) of C₆F₁₃I and 10 g of acetonitrile are introduced into a 100 ml two-necked round-bottom flask covered with a film of aluminum and equipped with a reflux condenser. The mixture is degassed using argon for 10 min at 0° C., followed by three vacuum/argon cycles, and then placed at 70° C. with magnetic stirring. The reaction is halted when the monomer is no longer consumed. The maximum conversion achieved is 70% (measured by ³¹P NMR). The polymer is obtained by precipitating from acetone, then filtered off and stored in the dark at 0° C. A white powder is obtained.

¹⁹F NMR, performed in deuterated water, clearly shows the presence of the signals of the C₆F₁₃— group. Only the signal of the CF₂ in the α position with regard to the iodine atom has disappeared at −60 ppm and a new signal characterizing the CF₂ in the a position with regard to the CH₂ of the VPA appears at −112 ppm. In addition, a Maldi-Tof analysis corroborates these results since the expected structure C₆F₁₃(VPA)ₙ₋₁-CH═CHPO₃H₂ is observed (H1 is eliminated at the chain end during the analysis). The very good dispersibility in water of the polymer formed is also characteristic of the formation of an amphiphilic polymer.

### Example 3

### Radical Polymerization of Vinylphosphonic Acid (VPA) in the Presence of CH₃CH(CO₂CH₃)I

5.0 g (4.67×10−2 mol) of VPA, 0.08 g (5.09×10⁻⁴ mol) of AIBN, 0.33 g (1.54×10⁻³ mol) of CH₃CH(CO₂CH₃)I and 10 g of acetonitrile are introduced into a 100 ml two-necked round-bottom flask covered with a film of aluminum and equipped with a reflux condenser. The mixture is degassed using argon for 10 min at 0° C., followed by three vacuum/argon cycles, and then placed at 70° C. with magnetic stirring. The reaction is halted when the monomer is no longer consumed. The maximum conversion achieved is 70% (measured by ³¹P NMR). The polymer is obtained by precipitating from acetone, then filtered off and stored in the dark at 0° C. A white powder is obtained.

The FTIR and ¹H NMR analyses characterize the presence of the ester functional group of the transfer agent at the chain end of the VPA oligomers. Specifically, the FTIR analysis shows the presence of the vibration of the carbonyl at 1710 cm⁻¹. ¹H NMR characterizes the peak of the methyl in the α position with regard to the carbonyl group. Finally, a kinetic study by gas chromatography shows that the iodine-comprising agent is consumed during the reaction.

### Example 4

### Synthesis of poly(methyl acrylate)-poly(vinylphosphonic acid) diblock copolymer

2.0 g (2.22×10⁻² mol) of methyl acrylate (MA), 0.379 g (2.31×10⁻³ mol) of azobisisobutyronitrile (AIBN), 0.294 g (1.16×10⁻³ mol) of iodine I₂ and 10 g of toluene are introduced into a 100 ml two-necked round-bottom flask covered with a film of aluminum and equipped with a reflux condenser. The mixture is degassed using argon for 10 min at 0° C. and then placed at 80° C. with magnetic stirring. The reaction is halted before complete conversion of the MA monomer. The crude reaction product is analyzed by GPC (eluent THF) and a molar mass Mₙ of 1100 g/mol (PMMA standards) is obtained with a polydispersity index M_{w}/Mₙ of 1.6. The ¹H NMR analysis shows the presence of the iodine atom at the chain end of the polymethyl acrylate by the peak at 4.5 ppm of the proton —CH— in the α position with regard to the iodine atom. The residual methyl acrylate is completely evaporated under vacuum before the following polymerization stage.

1.54 g (1.54×10⁻³ mol) of the polymethyl acrylate functionalized by an end iodine atom, 5.0 g (4.67×10⁻² mol) of VPA, 0.08 g (5.09×10⁻⁴ mol) of AIBN and 10 g of toluene are introduced into a 100 ml two-necked round-bottom flask covered with a film of aluminum and equipped with a reflux condenser. The mixture is degassed using argon for 10 min at 0° C., followed by three vacuum/argon cycles, and then placed at 70° C. with magnetic stirring. The reaction is halted when the monomer is no longer consumed. The maximum conversion achieved is 50% (measured by ³¹P NMR). After complete evaporation of the toluene under vacuum and addition of water, the polymer obtained forms a stable aqueous dispersion.

1-30. (canceled)

31. A process for the synthesis of a controlled-architecture copolymer comprising at least one block A obtained by the polymerization of a mixture of monomers comprising ethylenic unsaturation (A₀), but not comprising monomers having vinylphosphonate functional groups, and at least one block B obtained by the polymerization of a mixture of monomers comprising ethylenic unsaturation (B₀) comprising at least one monomer B₁ comprising at least one vinylphosphonate functional group comprising the following steps:
(a) performing a radical polymerization that results in the production of a polymer functionalized at its end by an iodine atom capable of use as a transfer agent in a controlled radical polymerization reaction,
said step carried out by bringing into contact:
ethylenically unsaturated monomer molecules,
a source of free radicals, and
at least one iodine-comprising transfer agent;
(b) performing, subsequent to step (a), at least one radical polymerization resulting in a block copolymer functionalized at its end by an iodine atom capable of use as transfer agent in a radical polymerization reaction,
step (b) being carried out by bringing into contact:
ethylenically unsaturated monomer molecules, at least one of which is different from the ethylenically unsaturated monomer molecules employed in the radical polymerization of step (a),
a source of free radicals, and
the functionalized polymer resulting from step (a);
wherein one of the polymerization steps (a) and (b) results in the formation of block A, and the other of the polymerization steps (a) and (b) results in the formation of block B,
further wherein a controlled-architecture copolymer is obtained.

32. A process for the synthesis of a controlled-architecture copolymer of telomer type comprising bringing into contact:
ethylenically unsaturated monomer molecules,
a source of free radicals, and
at least one iodine-comprising transfer agent,
wherein the controlled architecture copolymer of telomer type comprises at least one chain B, said chain B obtained by the polymerization of a mixture of monomers having ethylenic unsaturation (Bo), wherein B₀ comprises at least one monomer B₁, which includes at least one vinylphosphonate functional group.

33. The process of claim 31, wherein the amount of monomer B₁ comprises greater than 10 mol % of the block B.

34. The process of claim 31, wherein the amount of monomer B₁ comprises greater than 20 mol % of block B.

35. The process of claim 31, wherein the amount of monomer B₁ comprises greater than 50 mol % of block B.

36. The process of claim 31, wherein the iodine-comprising transfer agent comprises compounds of following formula (II):
R—I (II)
wherein:
R represents:
an alkyl, acyl, aryl, alkenyl or alkynyl group;
a saturated or unsaturated, optionally aromatic, carbon ring;
a saturated or unsaturated, optionally aromatic, heterocycle;
a polymer chain;
an iodine atom; or
HI₂C—;
when R is not an iodine atom or the HI₂C— radical, R additionally comprises at least one group that stabilizes the radical R and comprises from 1 to 50 carbon atoms,
wherein the polymer and the group that stabilizes the radical are bonded to the same carbon atom in R,
the at least one group that stabilizes the radical R comprises aryl, alkene, ester, acid, amide, ketone, nitrile, halogen, isocyanate, nitro, amine, or combinations thereof.

37. The process of claim 36, wherein the at least one group that stabilizes the radical R comprises C₆H₄CH₃, C₆H₅, (C═O)OCH₃, F, Cl, CN, or combinations thereof.

38. The process of claim 36, wherein the iodine-comprising transfer agent comprises 1-chloro-1-iodoethane, 1-fluoro-1-iodoethane, 1-phenyl-1-iodoethane, monoiodoperfluoroethane, monoiodoperfluoropropane, 2-iodoperfluorobutane, 1-iodoperfluorobutane, 1-iodoperfluoro(4-methylbutane), 1-iodoperfluorohexane, 1-iodoperfluoro-n-nonane, monoiodoperfluorocyclohexane, monoiodotrifluorocyclobutane, monoiododifluoromethane, monoiodomonofluoromethane, 2-iodo-1-hydroperfluoroethane, 3-iodo-1-hydroperfluoropropane, monoiodomonochlorodifluoromethane, monoiododichloromonofluoroethane, 2-iodo-1,2-dichloro-1,1,2-trifluoroethane, 4-iodo-1,2-dichloroperfluorobutane, 6-iodo-1,2-dichloroperfluorohexane, 4-iodo-1,2,4-trichloroperfluorobutane, 1-iodo-2,2-dihydroperfluoropropane, 1-iodo-2-hydroperfluoropropane, monoiodotrifluoroethane, 3-iodoperfluoroprop-1-ene, 4-iodoperfluoropentene, 1,4-iodo-5-chloropent-1-ene, 2-iodoperfluoro(1-cyclobutenyl)-ethane, 1-iodoperfluorodecane, 2-iodo-1,1,1-trifluoroethane, 1-iodo-1-hydroperfluoro(2-methylethane), 2-iodo-2,2-dichloro-1,1,1-trifluoroethane, 2-iodoperfluoroethyl perfluorovinyl ether, 2-iodoperfluoroethyl perfluoroisopropyl ether, 3-iodo-2-chloroperfluorobutyl perfluoro-methyl ether, iodopentafluorocyclohexane, iodoperfluorohexane, iodoacetonitrile, methyl 2-iodopropionate, ethyl 2-iodopropionate or benzyl iodide.

39. The process of claim 36, wherein the iodine-comprising transfer agent comprises 1-iodoperfluorohexane (C₆F₁₃I), iodoacetonitrile (CNCH₂I), methyl 2-iodopropionate (CH₃CH(CO₂CH₃)—I), 1-phenyl-1-iodoethane (CH₃CH(C₆H₅)—I) or benzyl iodide (C₆H₅CH₂—I).

40. The process of claim 31, wherein the iodine-comprising transfer agent comprises compounds of following formula (III):
Z₂-R′—I (III)
wherein R′ represents:
an alkylene or arylene group;
a saturated or unsaturated, optionally aromatic, carbon ring;
a saturated or unsaturated, optionally aromatic, heterocycle; or
a polymer chain;
further wherein R′ comprises at least one group that stabilizes the radical Z₂-R′ comprising from 1 to 50 carbon atoms,
further wherein the polymer and the at least one group that stabilizes the radical are bonded to the same carbon atom in Z₂-R′;
wherein the at least one group that stabilizes the radical R′ comprises aryl, alkene, ester, acid, amide, ketone, nitrile, halogen, isocyanate, nitro, amine or combinations thereof;
wherein the groups that stabilize the radicals Z₂-R′ comprise C₆H₄CH₃, C₆H₅, (C═O)OCH₃, F, Cl or CN;
wherein Z₂ comprises OR₁, N(R₁)₂, SR₁, COOR₁, COOM, an olefin of the CR₁═C(R₁)₂ type, epoxy, SO₃M, P(O)(OR₁)₂, P(R₁)₃, isocyanate or CR₁═O,
further wherein R₁ is a hydrogen atom or a group having from 1 to 20 carbon atoms,
further wherein R₁ is identical or different for any Z₂ comprising more than one R₁ group, and
wherein M is an alkali metal salt,
further wherein, the alkali metal is sodium or potassium.

41. The process of claim 40, wherein the iodine-comprising transfer agent Z₂-R′-1 comprises 3-iodo-4-chloroperfluorobutyric acid, allyl iodide, 1-iodo-1-phenylethanol of formula (IIIa) below, or iodoacetic acid of formula (IIIb) below:

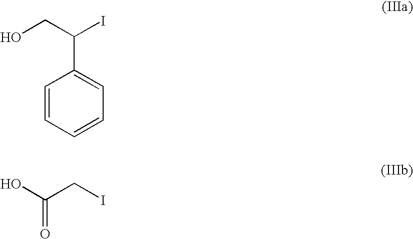

42. The process of claim 31, wherein the iodine-comprising transfer agent comprises compounds of following formula (IV):
I—R′—I (IV)
wherein R′ represents:
an alkylene or arylene group;
a saturated or unsaturated, optionally aromatic, carbon ring;
a saturated or unsaturated, optionally aromatic, heterocycle; or
a polymer chain;
further wherein R′ comprises at least one group that stabilizes the radical R′ and comprises from 1 to 50 carbon atoms,
further wherein the polymer and the at least one group that stabilizes the radical R′ is bonded to the same carbon atom in R′;
wherein the at least one group that stabilizes the radical R′ comprises aryl, alkene, ester, acid, amide, ketone, nitrile, halogen, isocyanate, nitro, amine or combinations thereof.

43. The process of claim 42, wherein the at least one group that stabilizes the radical R′ comprises C₆H₄CH₃, C₆H₅, (C═O)OCH₃, F, Cl, CN, or combinations thereof.

44. The process of claim 42, wherein the iodine-comprising transfer agent comprises 1,3-diiodoperfluoro-n-propane, 1,4-diiodoperfluoro-n-butane, 1,3-diiodo-2-chloroperfluoro-n-propane, 1,5-diiodo-2,4-dichloroperfluoro-n-pentane, 1,7-diiodoperfluoro-n-octane, 1,12-diiodoperfluorodecane, 1,16-diiodoperfluorohexadecane, 1,2-di(iododifluoromethyl)perfluorocyclobutane, 1,4-di(iododifluoromethyl)tetrafluorocyclohexane, 1,4-di(iodomethyl)benzene (IVa), ethylene glycol di(iodomethyl) ester (IVb) or dimethyl, 2,5-diiodoadipate (IVc).

45. The process of claim 44, wherein the iodine-comprising transfer agent comprises 1,4-di(iodomethyl)benzene (formula IVa below), ethylene glycol di(iodomethyl) ester (formula IVb below) or dimethyl 2,5-diiodoadipate (formula IVc below):

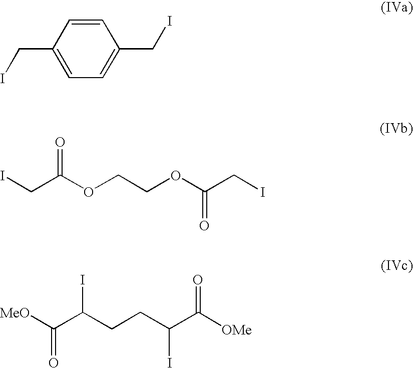

46. The process of claim 31, wherein the mixture of monomers A₀ comprises at least one monomer comprising hydrophilic monomers (h) or hydrophobic monomers (H) wherein the hydrophilic monomers (h) comprise:
unsaturated ethylenic mono- and dicarboxylic acids;
ethylenic monomers comprising a ureido group;
ethylenic monomers comprising a sulfonic acid group or one of its alkali metal or ammonium salts;
monomers comprising a boronic acid functional group;
cationic monomers;
the polyvinyl alcohol resulting from the hydrolysis of a polyvinyl acetate
the hydrophilic polymers originating from a chemical modification of a hydrophobic block; or
cyclic amides of vinylamine; and
wherein the hydrophobic monomers (H) comprise:
styrene-derived monomers;
esters of acrylic acid or methacrylic acid with C₁-C₁₂;
vinyl nitriles comprising from 3 to 12 carbon atoms;
vinyl esters of carboxylic acids;
vinyl or vinylidene halides; or
diene monomers.

48. The process of claim 46, wherein the mono- or dicarboxylic acid is acrylic acid, methacrylic acid, itaconic acid, maleic acid, or fumaric acid, and their derivatives.

49. The process of claim 46, wherein the ethylenic monomer comprising a ureido group is ethylene urea ethyl methacrylamide or ethylene urea ethyl methacrylate.

50. The process of claim 46, wherein the ethylenic monomer comprising a sulfonic acid group is vinylsulfonic acid, vinylbenzenesulfonic acid, α-acrylamidomethyl-propanesulfonic acid, 2-sulfoethyl methacrylate, or alkali metal or ammonium salts thereof.

51. The process of claim 46, wherein the cationic monomer is dimethylaminoethyl(meth)acrylate, dimethylaminopropyl(meth)acrylate, di(tert-butyl)aminoethyl (meth)acrylate, dimethylaminomethyl(meth)acrylamide, dimethylaminopropyl(meth)acrylamide; ethylenimine, vinylamine, 2-vinylpyridine, 4-vinylpyridine; trimethylammonioethyl(meth)acrylate chloride, trimethylammonioethyl acrylate methyl sulfate, benzyldimethylammonioethyl(meth)acrylate chloride, (4-benzoylbenzyl)dimethylammonioethyl acrylate chloride, trimethylammonioethyl(meth)-acrylamide chloride, trimethyl(vinylbenzyl)-ammonium chloride; diallyldimethylammonium chloride, mixtures thereof, or salts thereof.

52. The process of claim 46, wherein the cyclic amide of vinylamine is N-vinylpyrrolidone or vinylcaprolactam.

53. The process of claim 46, wherein the styrene derived monomer is α-methylstyrene, para-methylstyrene or para-(tert-butyl)styrene.

54. The process of claim 46, wherein the ester of acrylic acid or methacrylic acid is methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate.

55. The process of claim 46, wherein the vinyl nitrile is acrylonitrile or methacrylonitrile.

56. The process of claim 46, wherein the vinyl ester of a carboxylic acid is vinyl acetate, vinyl versatate or vinyl propionate.

57. The process of claim 46, wherein the vinyl or vinylidene halide is vinyl chloride, vinyl fluoride, vinylidene chloride or vinylidene fluoride.

58. The process of claim 46, wherein the diene monomer is butadiene or isoprene.

59. The process of claim 31, wherein the mixture of monomers A₀ comprises at least one hydrophilic monomer (h) comprising:
acrylic acid (AA), acrylamide (Am), 2-acryl-amido-2-methylpropanesulfonic acid (AMPS), styrenesulfonate (SS), N-vinylpyrrolidone, vinylsulfonic acid (VSA), the vinyl alcohol units resulting from the hydrolysis of polyvinyl acetate, or mixtures thereof;
or a hydrophobic monomer (H) comprising:
methyl acrylate, ethyl acrylate, propyl acrylate, butyl acrylate (BuA) or 2-ethylhexyl acrylate (2EHA), styrene, fluorinated acrylates, vinyl acetate (VAc), vinyl chloride, vinylidene chloride or vinylidene fluoride.

60. The process of claim 31, wherein the mixture of monomers A₀ comprises at least one monomer comprising acrylic acid (AA) or polyvinyl alcohol.

61. The process of claim 46, wherein the mixture B₀ comprises:
from 50 to 100 mol % of at least one monomer B₁ having a phosphonate functional group, and
from 0 to 50 mol % of at least one monomer B₂ comprising a mixture of monomers (A₀), wherein the mixture of monomers A₀ comprises at least one monomer comprising hydrophilic monomers (h) or hydrophobic monomers (H) wherein the hydrophilic monomers (h) comprise:
unsaturated ethylenic mono- and dicarboxylic acids;
ethylenic monomers comprising a ureido group;
ethylenic monomers comprising a sulfonic acid group or one of its alkali metal or ammonium salts;
monomers comprising a boronic acid functional group;
cationic monomers;
the polyvinyl alcohol resulting from the hydrolysis of a polyvinyl acetate
the hydrophilic polymers originating from a chemical modification of a hydrophobic block; or
cyclic amides of vinylamine; and
wherein the hydrophobic monomers (H) comprise:
styrene-derived monomers;
esters of acrylic acid or methacrylic acid with C₁-C₁₂;
vinyl nitriles comprising from 3 to 12 carbon atoms;
vinyl esters of carboxylic acids;
vinyl or vinylidene halides; or
diene monomers.

62. The process of claim 61, wherein the mono- or dicarboxylic acid is acrylic acid, methacrylic acid, itaconic acid, maleic acid, or fumaric acid, or their derivatives.

63. The process of claim 61, wherein the ethylenic monomer comprising a ureido group is ethylene urea ethyl methacrylamide or ethylene urea ethyl methacrylate.

64. The process of claim 61, wherein the ethylenic monomer comprising a sulfonic acid group is vinylsulfonic acid, vinylbenzenesulfonic acid, α-acrylamidomethyl-propanesulfonic acid, 2-sulfoethyl methacrylate, or alkali metal or ammonium salts thereof.

65. The process of claim 61, wherein the cationic monomer is dimethylaminoethyl(meth)acrylate, dimethylaminopropyl(meth)acrylate, di(tert-butyl)aminoethyl (meth)acrylate, dimethylaminomethyl(meth)acrylamide, dimethylaminopropyl(meth)acrylamide; ethylenimine, vinylamine, 2-vinylpyridine, 4-vinylpyridine; trimethylammonioethyl(meth)acrylate chloride, trimethylammonioethyl acrylate methyl sulfate, benzyldimethylammonioethyl(meth)acrylate chloride, (4-benzoylbenzyl)dimethylammonioethyl acrylate chloride, trimethylammonioethyl(meth)-acrylamide chloride, trimethyl(vinylbenzyl)-ammonium chloride; diallyldimethylammonium chloride, mixtures thereof, or salts thereof.

66. The process of claim 61, wherein the cyclic amide of vinylamine is N-vinylpyrrolidone or vinylcaprolactam.

67. The process of claim 61, wherein the styrene derived monomer is α-methylstyrene, para-methylstyrene or para-(tert-butyl)styrene.

68. The process of claim 61, wherein the ester of acrylic acid or methacrylic acid is methyl acrylate, ethyl acrylate, propyl acrylate, n-butyl acrylate, isobutyl acrylate, 2-ethylhexyl acrylate, t-butyl acrylate, methyl methacrylate, ethyl methacrylate, n-butyl methacrylate or isobutyl methacrylate.

69. The process of claim 61, wherein the vinyl nitrile is acrylonitrile or methacrylonitrile.

70. The process of claim 61, wherein the vinyl ester of a carboxylic acid is vinyl acetate, vinyl versatate or vinyl propionate.

71. The process of claim 61, wherein the vinyl or vinylidene halide is vinyl chloride, vinyl fluoride, vinylidene chloride or vinylidene fluoride.

72. The process of claim 61, wherein the diene monomer is butadiene or isoprene.

73. The process of claim 61, wherein the mixture of monomers A₀ comprises at least one hydrophilic monomer (h) comprising:
acrylic acid (AA), acrylamide (Am), 2-acryl-amido-2-methylpropanesulfonic acid (AMPS), styrenesulfonate (SS), N-vinylpyrrolidone, vinylsulfonic acid (VSA), the vinyl alcohol units resulting from the hydrolysis of polyvinyl acetate, or mixtures thereof;
or a hydrophobic monomer (H) comprising:
methyl acrylate, ethyl acrylate, propyl acrylate, butyl acrylate (BuA) or 2-ethylhexyl acrylate (2EHA), styrene, fluorinated acrylates, vinyl acetate (VAc), vinyl chloride, vinylidene chloride or vinylidene fluoride.

74. The process of claim 61, wherein the mixture of monomers A₀ comprises at least one monomer comprising acrylic acid (AA) or polyvinyl alcohol.

75. The process of claim 31 wherein the monomer B is a compound of formula (I): 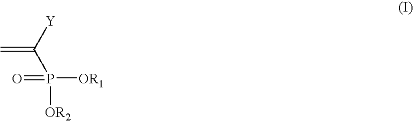
wherein:
Y is a hydrogen atom, an alkyl radical having from 1 to 6 carbon atoms, a cyano, a phenyl radical, an ester radical of formula —COOR₃, an acetate radical of formula —OCOR′₃, a phosphonic acid or a methyl, ethyl or isopropyl ester of phosphonic acid;
R₃ and R′₃, which are identical or different, are an alkyl radical having from 1 to 12 carbon atoms; and
R₁ and R₂, which are identical or different, are a hydrogen atom or an alkyl radical having from 1 to 6 carbon atoms which is optionally substituted by a halogen atom;
or their mixtures.

76. The process of claim 75, wherein when Y is other than a hydrogen atom, then the block B or the chain B also comprises monomers B₁ in which Y represents a hydrogen atom.

77. The process of claim 76, wherein the monomer B₁ is vinylphosphonic acid, the dimethyl ester of vinylphosphonic acid, the bis(2-chloroethyl) ester of vinylphosphonic acid, vinylidenediphosphonic acid, the tetraisopropyl ester of vinylidenediphosphonic acid, α-styrenephosphonic acid or their mixtures.

78. The process of claim 77, wherein the monomer B₁ is in the free acid form or in the form of their salts, or in the partially or completely neutralized form.

79. The process of claim 31 wherein the monomer B₁ is vinylphosphonic acid.

80. The process of claim 31, wherein the monomer B₂ is acrylic acid, acrylamide, vinylsulfonic acid, vinyl acetate, butyl acrylate or their mixtures.

81. The process of claim 31, wherein the monomer B₂ is acrylic acid.

82. The process of claim 31, wherein the polymerization is carried out in bulk, in solvent, or in dispersed medium.

83. The process of claim 82, wherein the solvent is acetonitrile, ethyl acetate or an alcohol.

84. The process of claim 83, wherein the alcohol is ethanol, isopropanol, or their mixtures with water.

85. A telomer produced by the process of claim 31.

86. The telomer of claim 85, wherein the telomer is a surface-modifying agent, an adhesion promoter, a corrosion inhibitor, a flame retardant, a dispersant or an emulsifier.

87. The process of claim 75, wherein R₃ and R′₃, which are identical or different, are an alkyl radical having from 1 to 6 carbon atoms.
